(19) United States
(12) Patent Application Publication
(10) Pub. No.: US 2019/0327093 A1
(43) Pub. Date: Oct. 24, 2019

(54) CLOUD-IMPLEMENTED PHYSICAL TOKEN BASED SECURITY

(71) Applicant: HABRAKEN HOLDINGS LLC, Austin, TX (US)

(72) Inventor: G. Wouter HABRAKEN, Austin, TX (US)

(73) Assignee: HABRAKEN HOLDINGS LLC, Austin, TX (US)

(21) Appl. No.: 16/462,325

(22) PCT Filed: Nov. 29, 2016
(86) PCT No.: PCT/US2016/063913

§ 371 Date: May 20, 2019

(51) Int. Cl. H04L 9/32

(52) U.S. Cl. CPC H04L 9/3234; H04L 9/3226; H04L 9/3268

(57) ABSTRACT

Various systems and methods for implementing physical token based security in a networked environment with localized security state management (SSM). Illustrative embodiments include: a cryptoprocessor-based physical security token; a network interface that receives commands directed via a network to the cryptoprocessor from a remote computer; a memory or persistent storage device storing SSM software; and one or more CPUs coupled to the memory or persistent storage device to execute the SSM software. The SSM software causes the one or more CPUs to implement an SSM method that includes: accepting commands, thereby obtaining a received command sequence; applying security rules to the received command sequence to obtain a modified command sequence; directing the modified command sequence to the cryptoprocessor; receiving from the cryptoprocessor responses to commands in the modified command sequence; and providing replies to commands in the received command sequence based on the cryptoprocessor responses and on the security rules.

### RELATED APPLICATION

This application is the National Stage of International Application No. PCT/US2016/063913, filed Nov. 29, 2016 which is specifically incorporated by reference in its entirety herein.

### BACKGROUND

Smart cards and other physical security tokens employ cryptographic techniques suitable for a reasonably secure verification of a user's identity. Security tokens enable secure methods for controlling user access to, e.g., protected systems, confidential information, and proprietary services. Security tokens are also an important ingredient for many digital signature protocols that authenticate sources of messages and information, prevent repudiation, and prevent tampering. Further, security token based cryptographic techniques are useful to securing certain encrypted messaging protocols against eavesdropping. These examples are merely illustrative of a broader class of security token-reliant security methods.

To ensure that the security token is in the user's possession, modern security token procedures also employ one or more additional factors such as prompting the user for a password or personal identification number (PIN) and/or acquiring a biometric measurement (e.g., scanning of a palm, fingerprint, face, iris, retina, or voiceprint). Other additional factor candidates are contemplated and may prove to be suitable, such as reaction time or other behavior analysis, sensing of mobile phones or other near field communication devices associated with the user, and connection of the security token to a trusted system.

It is expressly noted here that security tokens can be implemented in virtual forms, perhaps as emulations stored on a portable storage device (e.g., a flash drive) or portable computer (e.g., a laptop, tablet, or mobile phone) with adequate protections against compromise. The phrase “physical security token” is intended to include not only smart cards and other hardware-implemented security tokens, but also any virtual embodiments of such tokens so long as they are embedded in a physical device. Such flexibility enables better accommodation of user preferences.

Existing physical security token based procedures (and associated security methods) are intended for use in localized systems such as the stand-alone computer system of FIG. 1. The illustrated system has a computer 102 with peripherals including a smart card reader 104 and a user interface 106 (shown here as a keyboard and display screen). Peripheral buses 108, 110 including (among many other suitable examples) universal serial bus (USB), high definition multimedia interface (HDMI™), and Thunderbolt™, support communications between the peripherals and the computer 102. Once the user inserts a smart card 112 in reader 104, the computer 102 can access it as part of a multi-factor security procedure that includes, e.g., obtaining a PIN via user interface 106. So long as the localized system is kept in a controlled environment that enforces reasonable protection measures against hardware or software tampering, such token-reliant security procedures are unlikely to be compromised.

Cloud computing environments offer scalability and numerous other potential advantages over localized systems, but sacrifice the level of control needed to protect against compromise of security token-reliant security methods. For example, cloud computing environments communicate with local peripherals such as a smart card reader via network components and protocols that may not be subject to reasonable protection measures against hardware and software tampering. If employed in a cloud-computing environment, existing token-reliant security methods would be undesirably vulnerable to attack.

### SUMMARY

Accordingly, there are disclosed herein various systems and methods for implementing physical token based security in a networked environment. Certain illustrative method embodiments provide localized security state management (SSM) by: intercepting commands directed to a locally-connected cryptoprocessor from one or more sources on a remote computer or virtual machine, thereby obtaining an intercepted command sequence; applying a set of one or more security rules to the intercepted command sequence to obtain a modified command sequence; directing the modified command sequence to the cryptoprocessor; receiving from the cryptoprocessor a response to each command in the modified command sequence; and providing, to the one or more sources, replies for each of the intercepted commands based on the cryptoprocessor responses and on the set of one or more security rules.

Certain illustrative system embodiments providing localized SSM include: a removeable or embedded cryptoprocessor, optionally having a persistent key store; a network interface that receives commands directed via a network to the cryptoprocessor from one or more sources on a remote computer; a memory or persistent storage device storing security state management (SSM) software; and one or more central processing units (CPUs) coupled to the memory or persistent storage device to execute the SSM software. The SSM software causes the one or more CPUs to implement an SSM method that includes: accepting said commands, thereby obtaining a received command sequence; applying a set of one or more security rules to the received command sequence to obtain a modified command sequence; directing the modified command sequence to the cryptoprocessor; receiving from the cryptoprocessor responses to commands in the modified command sequence; and providing, to the one or more sources, replies to commands in the received command sequence based on the cryptoprocessor responses and on the set of one or more security rules. The set of one or more security rules prevents user-provided authentication information from traversing the network.

Each of the foregoing embodiments may be employed individually or in combination, and in any case may include one or more of the following features in any suitable combination: (1) said intercepting, applying, directing, receiving, and providing operations being performed by a client computer having the cryptoprocessor as a physically-connected peripheral, with the client computer being coupled to the remote computer or virtual machine via a network, and the set of one or more security rules operating to prevent user-provided authentication information from traversing the network. (2) the method further includes monitoring whether the cryptoprocessor is in an authenticated state, with the set including at least one security rule that delays an intercepted command for a cryptographic operation until the cryptoprocesor is in an authenticated state. (3) the method further includes: detecting that the cryptoprocessor is not in the authenticated state; and inserting one or more commands in the modified command sequence to place the cryptoprocessor in an authenticated state. (4) the method further includes: prior to said inserting, prompting a user to provide a personal identification number (PIN) or other identification information; and generating the one or more inserted commands based at least in part on user-provided information. (5) the method further includes discarding the user-provided information to prevent further usage after said generating. (6) the method further includes, prior to said inserting, performing an authentication procedure with a security mechanism independent of the cryptoprocessor. (7) the security mechanism is a cryptoprocessor-based smart card or trusted platform module. (8) the method further includes monitoring whether the cryptoprocessor is in an authenticated state, with the set including at least one security rule that preserves the security state after an authenticated state is reached. (9) the at least one security rule prevents the modified command sequence from having commands that would disrupt the authenticated state. (10) the method further includes determining, based on responses from the cryptoprocessor, a class to which the cryptoprocessor belongs, where said set includes at least one security rule that, based the cryptoprocessor's class, blocks all or at least some predetermined types of response information from being included in said replies to the one or more sources. (11) said determining includes analyzing the cryptoprocessor's answer to reset. (12) said providing includes applying an additional security rule to the cryptoprocessor responses to enable source access to only selected types of cryptographic information. (13) the selected types of cryptographic information comprise digital certificates issued by a predetermined certification authority. (14) said set of one or more security rules blocks commands from unauthorized sources. (15) the method includes, as part of applying the set of security rules: detecting that the cryptoprocessor is not in the authenticated state; prompting a user to provide a personal identification number (PIN) or other identification information; generating one or more commands for authentication based at least in part on the user-provided information; and inserting the one or more commands for authentication in the modified command sequence to place the cryptoprocessor in an authenticated state. (16) the method includes, as part of applying the set of security rules: discarding the user-provided information to prevent further usage after said generating. (17) the method includes, as part of applying the set of security rules: determining, based on responses from the cryptoprocessor, a class to which the cryptoprocessor belongs, wherein said set of one or more security rules, based on the cryptoprocessor's class, blocks all or at least some predetermined types of response information from being included in said replies to the one or more sources. (18) the method includes, as part of providing replies to the one or more sources: applying one or more security rules from the set to the cryptoprocessor responses to block access by the one or more sources to digital certificates not issued by a predetermined certification authority.

### BRIEF DESCRIPTION OF THE DRAWINGS

In the drawings:

FIG. 1 shows an illustrative stand-alone computer system.

FIG. 2 shows an illustrative networked computer system.

FIG. 3 is a block diagram of an illustrative client computer.

FIG. 4 is a function-module diagram of an illustrative stand-alone computer system.

FIG. 5 is a function-module diagram of an illustrative networked computer system.

FIG. 6A is a function-module diagram of an illustrative client computer with a first security state manager (SSM) embodiment.

FIG. 6B is a function-module diagram of an illustrative client computer with a second SSM embodiment.

FIG. 7 is a timeline of an illustrative vulnerable transaction sequence.

FIG. 8 is a timeline of an illustrative transaction sequence with localized personal identity verification (PIV).

FIG. 9 is a timeline of an illustrative transaction sequence with command insertion, blocking, delay, and response filtering.

FIG. 10 is an architecture of an illustrative SSM embodiment.

FIGS. 11A and 11B are flow diagrams of an illustrative SSM method.

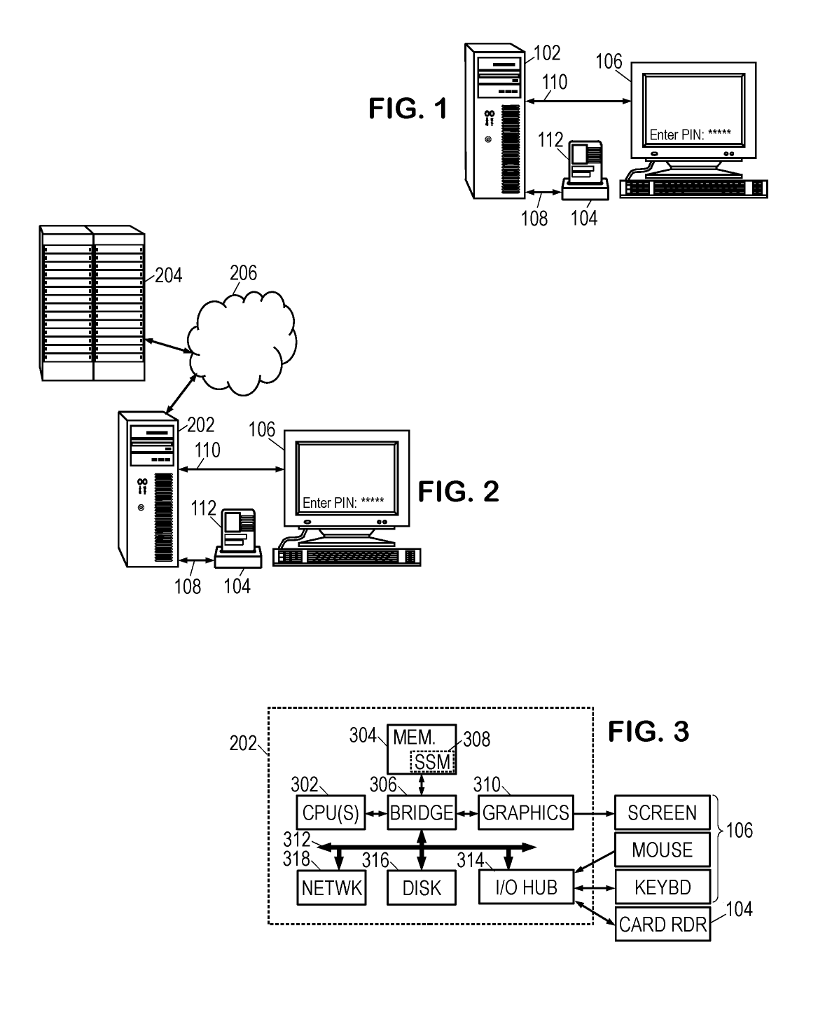

It should be understood that the drawings and corresponding detailed description do not limit the disclosure, but on the contrary, they provide the foundation for understanding all modifications, equivalents, and alternatives falling within the scope of the appended claims.

### DETAILED DESCRIPTION

Cloud computing exploits a network of distributed computing resources to provide services, such as Virtual Desktop Infrastructure (VDI), which use shared hardware resources to instantiate one or more virtual computers (aka “virtual machines”) accessible by the user from a client computer. Among the characteristic advantages of such services is the flexibility that companies can achieve with relatively little cost. The client computers carry very little of the computational burden and hence may take the form of inexpensive or legacy desktops. Yet the virtual machines can be configured as up-to-date late model computers having a standardized configuration for all employees, greatly simplifying IT management duties. Moreover, the virtual machines are created and discarded as needed, with no associated real-world requirements for purchasing, delivery, setup, tracking, disposal, etc. Additionally, cloud computing environments typically provide distributed high-availability designs that automatically protect against data loss in the event of hardware failures or power outages.

In a form simplified to components relevant for cloud computing, FIG. 2 shows a networked computer system in which a client computer 202 is coupled to a remote computer (e.g., server array 204) by a computer network 206. In practice, many such client computers 202 will be coupled to the network 206 and can each take any of a variety of forms including not only the illustrated desktop computer, but also laptops, notebooks, tablets, personal data assistants (PDAs), mobile phones, and indeed any form having a programmable processor coupled to a user interface 106 and a physical security token such as smart card 112. Similarly, the server array 204 would generally be only one of many such server arrays coupled to the computer network as a platform for an infrastructure supporting on-demand allocation of computer resources in forms such as virtual machines. Computer network 206 is shown as a cloud to minimize unnecessary detail, but may be expected to include an arrangement of routers, switches, and servers, interconnected to provide packet-switched communications between the network components as needed to support a communications link between end points such as the client computer 202 and server array 204.

FIG. 3 is a block diagram of an illustrative client computer 202, showing one or more central processing units (CPUs) 302 coupled to a system memory 304 by a bridge module 306. The bridge module 306 further enables the one or more CPUs 302 to communicate with a graphics processor 310 that drives the display portion of user interface 106. The bridge module 306 also supports communications of the CPUs 302 and system memory 304 with various peripherals via an input/output (I/O) bus 312. External peripherals such as smart card reader 104 are coupled to the I/O bus 312 by an I/O hub 314. Internal peripherals, such as a disk drive or other persistent information storage device 316 and a wired or wireless network interface 318, may be directly coupled to the I/O bus 312.

Upon powering-up of the client computer 202, the CPUs 302 may retrieve operating system (OS) components and other software modules from disk 316 and store them in system memory 304 (i.e., “load the software”) for execution. Alternatively, the CPUs 302 may load and execute some software modules in response to actions or commands received via the user interface 106, or perhaps in response to other actions such as the insertion of a smart card into reader 104. In accordance with the methods discussed further below, the loaded software may include a security state management (SSM) module 308, shown in FIG. 3 as resident in system memory 308. SSM module 308, when executed by one or more of the CPUs 302, causes them to implement an SSM method that may protect against certain vulnerabilities of traditional security token-reliant security methods when implemented in the cloud.

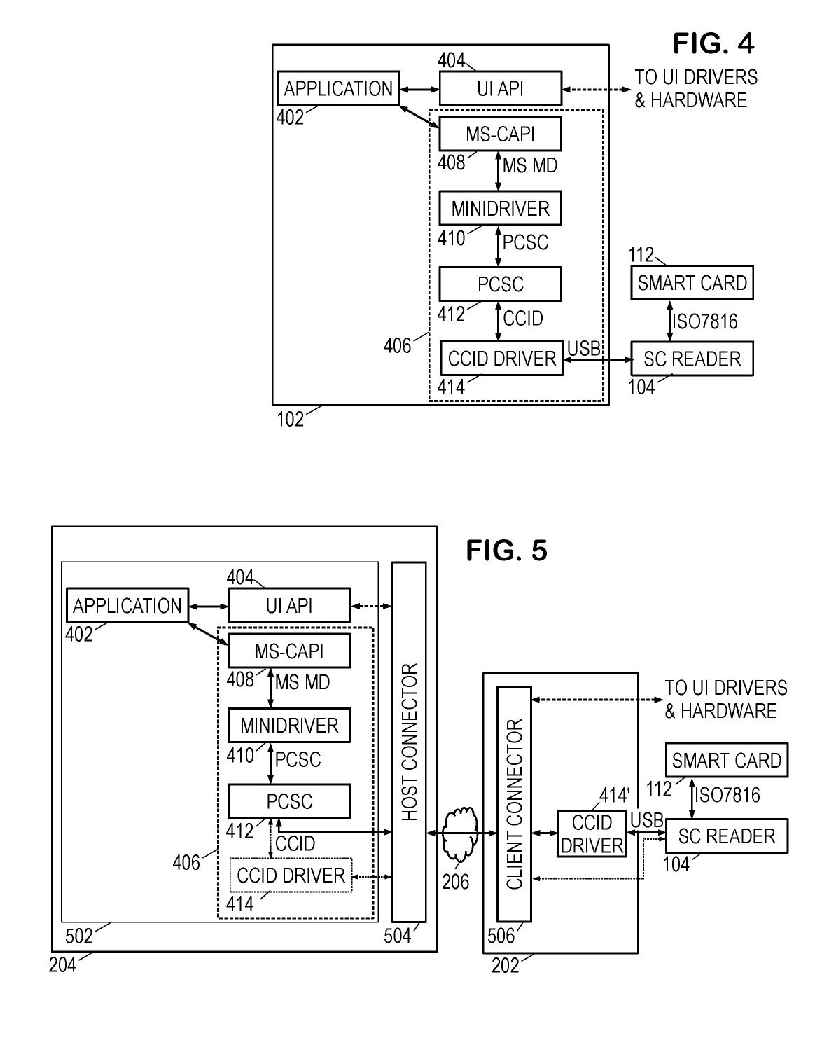

Turning now to a closer examination of software, FIG. 4 is a diagram of function modules that may be found within a stand-alone computer system implementing physical token-based Personal Identity Verification (PIV) as part of a PIV-reliant security method for, e.g., access control, authentication, or encrypted communication. The PIV-reliant security method may be implemented by an application program 402 executing on computer 102. The application program 402 employs the user interface (UI) via an application programming interface (API) implemented by a software library, UI API 404, to prompt and provide feedback to the user, and to detect user actions or acquire user input. (Though user interaction generally requires low level drivers and additional hardware, those are omitted here to avoid unduly complicating the explanation.)

Application program 402 further employs a cryptographic API 406 to communicate with a physical security token, which in this example takes the form of smart card 112 coupled to reader 104, but could take alternate forms such as a token having a universal serial bus (USB) port or a token accessible via a near field communication (NFC) protocol such as Bluetooth. The physical security token is preferably cryptoprocessor-based, meaning that it employs a processor dedicated to carrying out cryptographic operations using persistent keys that are protected from external access.

Using the cryptographic API 406, application program 402 initiates cryptographic operations on the physical security token 112 and receives responses. Illustrative cryptographic operations include encrypting data with a public key, decrypting data with a private key, obtaining a digital certificate including a public key signed by a certification authority (CA), authentication of user-provided information, and the generation of cryptographic keys, the importation of cryptographic keys, the importation of digital certificates, the loading and unloading of application data, setting configuration data such as the number of authentication tries and the length of a user authenticator such as a PIN, and blocking and unblocking of user credentials.

Suitable standards, both existing and contemplated, for cryptographic API 406 include Microsoft CryptoAPI, CryptoAPI Next Generation (CNG), Public-Key Cryptography Standard #11 (PKCS11), and NIST SP800-73 titled “Interfaces for Personal Identity Verification” (FIPS 201 or “PIV”). Suitable standards both existing and contemplated, for physical security token 112 include Public-Key Cryptography Standard #15 (PKCS15 or ISO/IEC 7816-15), NIST SP800-73, and Generic Identity Device Specification (GIDS) v2.0. FIG. 4 shows an illustrative software stack for the Microsoft CryptoAPI. A front-end library 408 implements the Microsoft CryptoAPI, making standard-compliant function calls available to the application program 402 for carrying out the cryptographic operations mentioned above. The front-end library 408 may be responsible for implementing the token-specific transactions needed to carry out the cryptographic operations. It maintains the context and state information for the token and may further provide data caching to minimize I/O traffic with the token.

Minidriver 410 may be a dynamically-linked library (DLL) that supports a token-specific API (i.e., an API associated with a given physical security token) such as that defined by the Windows Smart Card Minidriver Specification. The supported API calls include a pointer to a token-specific data structure having the state and context information for the card, and may further include a table of function calls usable by the minidriver to communicate with the front-end library. Minidriver 410 transforms the transaction request(s) into a sequence of token-specific commands, and correspondingly translates token-specific responses into transaction responses. In at least some implementations, the token-specific commands and responses take the form of application protocol data units (APDUs) compliant with the ISO/IEC 7816-4 standard, and more specifically, the subset of APDUs compliant with the PIV Card Command Interface Specification.

Personal computer smart card (PCSC) module 412 is a resource manager, enabling shared access by multiple applications to a given physical token, and providing a common node through which a given application can access multiple physical tokens. PCSC module 412 converts what may be multi-threaded command sequences from multiple minidrivers 410 into a command sequence suitable for a physical security token that supports only single-threaded access, and directs the sequence of responses to the currently-active minidriver 410.

Chip card interface device (CCID) driver 414 packages the commands for communication across a Universal Serial Bus (USB) link to a peripheral, in this case smart card reader 104. CCID driver 414 further extracts responses from communications received from the smart card reader and provides them to the PCSC module 412. Conversely, smart card reader 104 extracts commands from the USB communications and supplies the commands to smart card 112, and packages responses from the smart card 112 for USB communication to the CCID driver 414. The smart card 112 performs operations based on the received command APDUs and provides for each command APDU at least one response APDU.

In the context of a networked computer system, the function modules may be arranged as provided in FIG. 5. Software modules 402-406 execute on a virtual machine 502 that has been instantiated on server array 204. A host connector 504 and a client connector 506 cooperate to hide the communications link across network 206, enabling the virtual machine 502 to behave as if it were directly connected to the reader 104 and user interface peripherals 106. Host connector 504 intercepts the communications directed by UI API 404 to the UI drivers and hardware, funneling them via the network 206 to the client connector 506 on client computer 202. The client connector routes the intercepted communications to the local UI drivers and hardware and captures any responses or user input. These responses and input are returned via the network 206 to the host connector 504, which directs them to the UI API 404. Similarly, host connector 504 captures the sequence of commands from cryptographic API 406 (preferably from PCSC module 412, but alternatively from CCID driver 414), routes them via the network to client connector 506 which directs them to the smart card reader 104 (preferably via local CCID driver 414′, but alternatively via a PCSC module on the client computer 202. Responses from the reader 104 are captured by the client connector 506 and transmitted via network 206 to host connector 504, which directs the responses to API 406.

Physical security tokens (such as smart cards) that employ cryptoprocessors will typically decline commands to perform a cryptographic operation unless they have first been placed into a suitable authorized state. (Different operations may require different authorized states.) Where user-provided information (e.g., a password or PIN) is needed to place the security token into an authorized state, responsibility for acquiring that information and supplying it to the security token is allocated (in the configurations of FIGS. 4 and 5) to the front-end library 408 or, in some cases, to the application program 402 or the Minidriver 410. In the configuration of FIG. 5, this allocation requires the user-provided information to traverse the network 206 (twice!), making this information susceptible to interception and misuse.

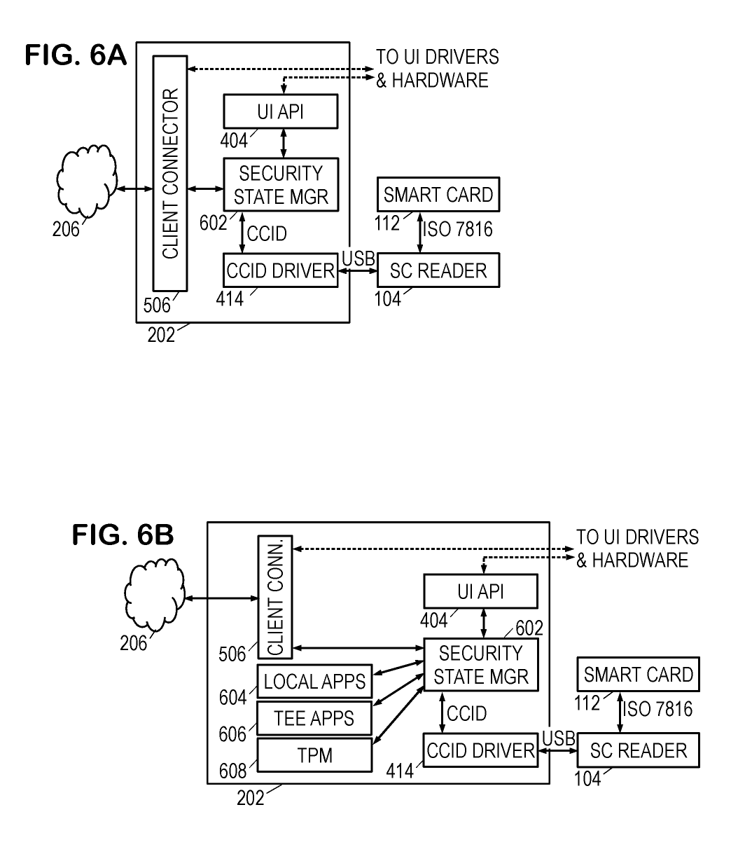

To protect against this vulnerability while still enabling the virtual machine 502 to treat the physical security token as a locally-connected peripheral, the configuration of FIG. 6A employs a security state manager (SSM) 602 executing on the client computer 202 to provide localized enforcement of certain security rules and, if desired, to implement additional security rules that can provide additional protections not found in the configuration of FIG. 5. As before, a host connector 504 intercepts a sequence of commands from PCSC module 412 and directs them to client connector 506. In the configuration of FIG. 6, the client connector directs this sequence of commands to SSM 602 rather than directly to the CCID driver 414 and/or reader 104.

SSM 602 applies a set of one or more security rules to the intercepted sequence of commands, blocking, delaying, inserting, and/or changing commands to obtain a modified sequence of commands that are directed to the smart card 112 via the CCID driver 414 and reader 104. At least one of the security rules preferably protects against transmission of user-provided authentication information across network 206 by monitoring an authentication state of the cryptoprocessor and, upon detecting that the authentication state is unsuitable for the cryptographic operation being requested by the intercepted command, implementing a localized authentication procedure to place the cryptoprocessor in a suitable authentication state before forwarding the intercepted command. As part of the localized authentication procedure, SSM 602 employs UI API 404 to prompt the user to provide the necessary authentication information, and upon acquiring the authentication information, SSM 602 generates the corresponding authentication commands for insertion in the modified command sequence.

SSM 602 receives at least one response for each command in the modified sequence. The SSM 602 may further apply the set of one or more security rules to the responses. Based on the security rules and responses, the SSM 602 provides responses to the commands in the intercepted sequence (hereafter, responses to commands in the intercepted sequence will be termed “replies”).

Before discussing the security rules and operation of the SSM 602 in detail, reference is made to FIG. 6B, showing additional local hardware or software modules residing on client computer 202. SSM 602 may be accessed not only by the client connector 506, but in some embodiments may also be accessed by local application programs 604 (preferably with an intermediate cryptographic API). Where the client computer is a mobile device, the local application programs may execute in a Trusted Execution Environment (TEE) 606, providing a secure sandbox to restrict interactions with TEE apps.

The client computer 202 may further include a trusted platform module (TPM) 608, a cryptoprocessor-based security component integrated into the hardware (typically soldered to the motherboard) of the computer. In some embodiments, the SSM 602 interacts with the TPM 608 as part of a localized process for authenticating smart card 112.

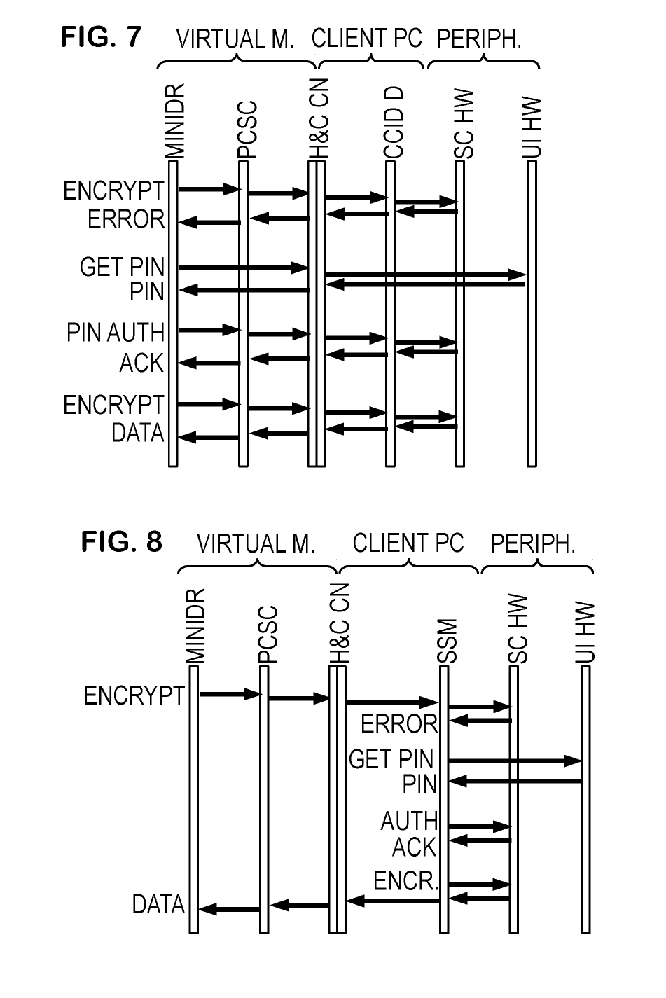

FIG. 7 is a timeline of an illustrative transaction sequence on a networked system lacking SSM 602. The application program 402 executing on the virtual machine initiates, via minidriver 410, a cryptographic operation (in this example, a request to encrypt data). Minidriver 410 passes the encrypt command to PC SC, which in turn passes it to the host connector and the client connector (which operate to hide the network 206). The client connector passes the encrypt command to CCID driver 414 which passes it to the smart card 112 (via reader 104). Because the smart card 112 is not in a suitable authentication state, it returns an error response along the chain to the minidriver 410. In the illustrated system, responsibility for authentication resides with minidriver 410 (or the program 402), so a prompt to obtain user authentication information (in this example, “GET PIN”) is sent, via the host and client connectors, to the user interface on the client computer, and via the user interface and the connectors the user provides the requested information. At this point, the user provided information has traversed the network 206 once, and it does so again as part of an authentication command that passes along the chain to the smart card. If the authentication information is correct, the smart card's cryptoprocessor enters a user-authentication state and returns an acknowledgement response along the chain to the minidriver 410. The minidriver 410 then retries the encrypt command and this time the smart card 112 responds with the encrypted data.

FIG. 8 is a timeline of an illustrative transaction sequence with a localized authentication process by SSM 602. In this sequence, the SSM 602 monitors the authentication state of the smart card 112. Upon receiving the initial encryption command and recognizing that the smart card 112 is not in a suitable authentication state (which might be determined by attempting the command and receiving an error response), SSM 602 prompts the user for the authentication information and, having obtained it, generates a suitable authentication command locally for insertion into the sequence of commands provided to the smart card. Upon receiving the acknowledgement response indicating a suitable authentication state, SSM 602 directs the initial encryption command to the smart card 112 and, upon obtaining the response, forwards the encrypted data up the chain as a reply to the encryption command in the intercepted sequence.

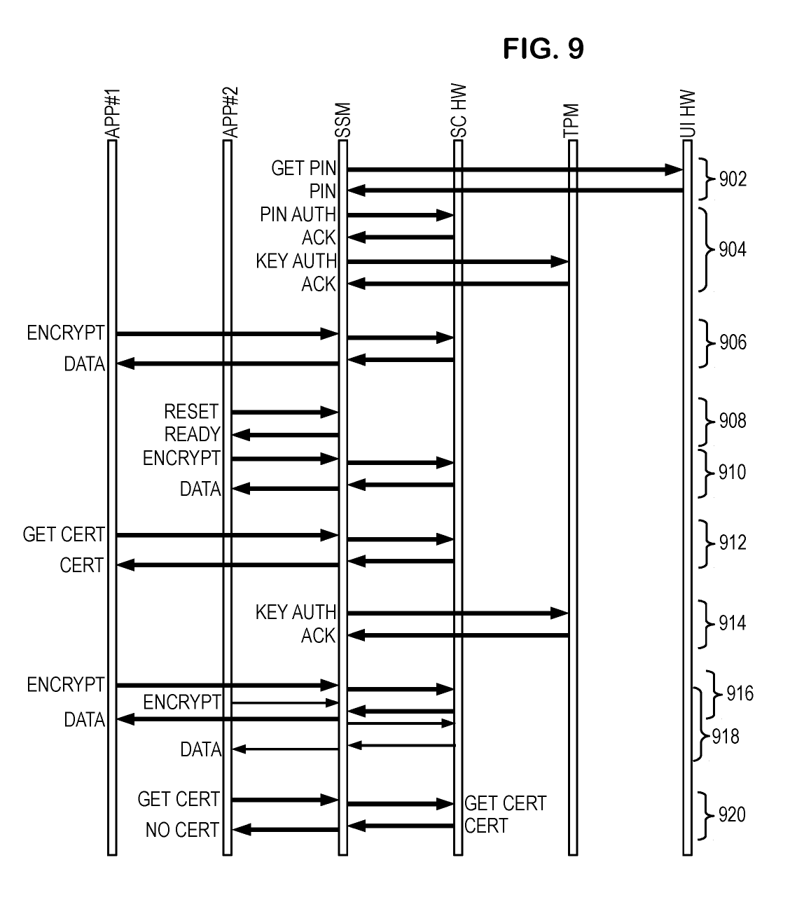

FIG. 9 is a timeline of an illustrative transaction sequence that illustrates other behaviors and command sequence modifications that may be implemented by SSM 602. In this example, the SSM 602 does not wait for an initiating cryptographic operation command, but instead initiates a localized authentication procedure upon, e.g., detecting insertion of the smart card. At 902, the SSM prompts a user for authentication information and obtains it from the user interface.

At 904, the SSM generates and sends an authentication command to the smart card and receives an acknowledgement indicating that the smart card is in a suitable authentication state. In the acknowledgement or in response to a subsequent command, the SSM obtains a cryptographic challenge from the smart card and supplies it to the TPM to verify that the smart card is authorized for usage on the client computer. An affirmative acknowledgement completes the localized authentication procedure, enabling the SSM to process subsequent commands for cryptographic operations, e.g., the encryption operation at 906.

As an added security measure, the key verification procedure may be periodically repeated with the TPM as indicated at 914. This example is but one of many possible localized authentication procedures that employ not only user-provided information, but multiple physical security tokens. In addition to or alternatively to the smart card and the TPM, illustrative authentication procedures may further employ multiple smart cards, USB tokens, Bluetooth tokens, and mobile phone proximity detectors to add further confidence in the PIV process.

FIG. 9 shows multiple applications (APP#1, APP#2) using the smart card. At 908, the second application attempts to reset the smart card before beginning any cryptographic operations. The SSM determines that this reset command would disrupt the existing authentication state of the smart card and blocks the reset command from reaching the smart card, simply replying to the reset command with an indication that the smart card is ready to receive commands such as, e.g., the subsequent encrypt command at 910.

At 912, the first application sends a command to obtain a digital certification. The SSM may impose restrictions upon which applications (or other sources of intercepted commands) are permitted to receive certificates, or may conversely restrict which types of digital certificates can be retrieved from the smart card. Such restrictions might be contemplated, for example, with government computer systems to deny access by non-authorized programs to physical security tokens, and to limit the digital certificates that are retrieved from such tokens by authorized programs to those certificates that have been signed by the government as a certification authority (CA). At 912, any such requirements are satisfied and the certificate is supplied the first application. At 920, however, the SSM determines that the digital certificate returned by the smart card is not of the required type (or that the second application is not authorized to receive it) and blocks the response from reaching the second application. Instead, the second application is provided with an unsuccessful reply of “no such certificate”.

At 916 and 918, the cryptographic operations attempted by the different applications conflict, with the second encryption command arriving at the SSM before the pending command has completed. The SSM delays the second encryption command until a response to the first is received, and provides a successful reply in due course.

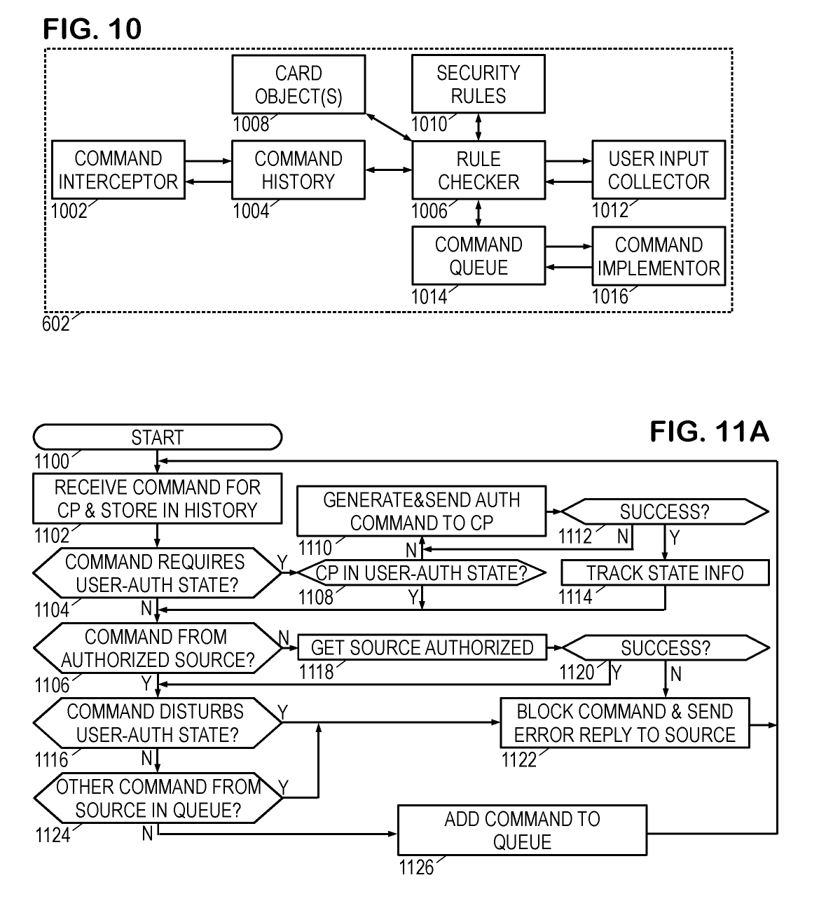

FIG. 10 shows an architecture of an illustrative SSM 602. A command interceptor 1002 receives commands directed to the physical security token for cryptographic (and administrative) operations, and places them in a list called command history 1004. A rule checker 1006 analyzes each command based on authentication state(s) of the security token(s) (as monitored and tracked in a Card Object structure 1008), a set of security rules 1010, and optionally based on past command history 1004.

If the analysis indicates that the token is not in a suitable authentication state, the rule checker 1006 triggers the user input collector 1012 to use the UI API to prompt for and obtain authentication information from the user. User-provided authentication information causes the rule checker 1006 to generate an authentication command and insert it in the command queue 1014.

If the analysis indicates that the token is in a suitable authentication state and the command is permitted pursuant to the remaining security rules, the rule checker 1006 places the command in the command queue 1014. A command implementor 1016 sends commands from the queue 1014 to the physical security token and accepts the responses from the physical security token, pairing the responses with the now “retired” commands in the queue 1014. The rule checker 1006 analyzes the responses based on the security rules and supplies the command interceptor 1002 with suitable replies for the commands in history 1004.

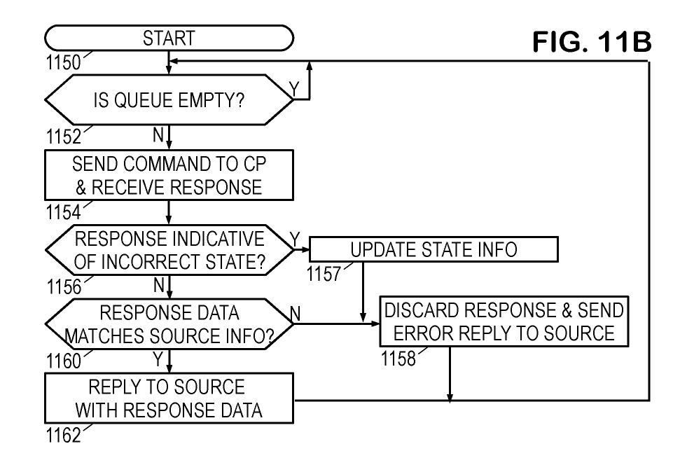

FIGS. 11A and 11B are flow diagrams of illustrative forward and return processes that may be implemented by SSM 602. Though the operations are shown sequentially, it should be noted that at least some of the operations could be performed asynchronously or concurrently in a multi-threaded environment.

The forward process 1100 begins in block 1102 with receiving a command directed to the cryptoprocessor and storing it in a command history list. In block 1104, the SSM implements a first security rule, checking to see if the command requires the cryptoprocessor to be in a user-authorization state. If not, the flow proceeds to block 1106. Otherwise, in block 1108, the SSM determines if the cryptoprocessor is indeed in a user-authorization state. If so, the flow proceeds to block 1106. Otherwise, the SSM (after obtaining user-authorization information) generates and sends an authorization command to the cryptoprocessor in block 1110. Though not specifically shown here, the SSM preferably discards the user authorization information after sending the authorization command so as to prevent it from being used for any purpose thereafter. In block 1112, the SSM determines if the authorization command was successful. If not, the flow returns to block 1110 for a second attempt. Otherwise, the authorization state information for the token is updated in block 1114, and the flow proceeds to block 1106.

In block 1106, the SSM implements a second security rule, checking to verify that the command was received from an authorized source. For example, some embodiments may prohibit the SSM from accepting commands from local applications not executing in a trusted execution environment or, other embodiments, from any applications not on an approved list. If the source is authorized, the flow proceeds to block 1116. Otherwise the SSM in block 1118 employs the UI API to obtain approval from the user to authorize the source. In block 1118, the SSM determines if the source has been authorized and, if so, the flow proceeds to block 1116. Otherwise, in block 1122 the SSM blocks the command from being sent to the security token and sends an error reply to the source. From block 1122, the flow returns to block 1102.

In block 1116, the SSM implements a third security rule, checking to determine if the command would disrupt the user-authorization state. If so, the flow proceeds to block 1122. Otherwise, in block 1124 the SSM implements a fourth security rule, checking to determine if that source already has a pending command in the command queue. If so, the flow proceeds to block 1122. Otherwise the SSM queues the command for sending to the physical security token and the flow returns to block 1102 for the next command.

The return process 1150 begins in block 1152, with the SSM determining whether any commands have been placed in the command queue. The SSM remains in block 1152 until a command is queue up for the cryptoprocessor, at which time the SSM sends the command to the cryptoprocessor 1154 and obtains a response. In block 1156, the SSM determines if the cryptoprocessor's response accords with the monitored authorization state information (see discussion of FIG. 10, object 1008 and FIG. 11A, block 1114). If not, for example if the response is an error response or otherwise indicates that the physical security token is not in the expected authorization state, the SSM updates the authorization state information in block 1157. (The forward process can then detect and rectify the improper state when processing the next command.) After updating the authorization state information, the SSM discards the response and replies to the source of the queued command with an error message. Thereafter, the flow proceeds back to block 1152.

Returning to block 1156, if the response is consistent with the expected authorization state, the SSM analyzes the response in block 1160. One or more security rules may be applied at this point to confirm that the information contained in the response is of a type that the source of the queued command is authorized to receive. For example, if the response contains a certificate from an unrecognized certification authority, the SSM blocks the response in block 1158. Assuming that the source is authorized to receive the response, the SSM replies to the source with the data from the response.

Embodiments of networked computer systems employing the SSM may offer a number of potential advantages in addition to eliminating the network traversals by the user-provided authentication information. The SSM may incorporate awareness of additional security token factors including platform factors such as TPM and OS code signatures. The SSM further enables the persistence of authentication state without caching of user-provided authentication information and without requiring unduly repetitious re-entry of that information by the user. Such persistence further enables the SSM to resolve conflicts between multiple applications competing for token access and session control, and blocks time-wasting resets and other administrative commands from applications operating with incomplete knowledge of the token's authentication state. The SSM can further implement security rules that identify token types, e.g., via analysis of the token's answer to reset (“ATR”), and based thereon, block or enable access to authorized types of tokens.

The preceding references to “one embodiment” or “an embodiment” mean that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but in some cases it may. Furthermore, while some embodiments described herein include some but not other features included in other embodiments, combinations of features of different embodiments are meant to be within the scope of the invention, and form different embodiments, as would be understood by those skilled in the art. Inventive aspects may lie in less than all features of a single foregoing disclosed embodiment.

The terms first, second, third and the like in the claims or/and in the Detailed Description, as used in a portion of a name of an element are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Numerous variations and modifications will become apparent to those skilled in the art once the above disclosure is fully appreciated. It is intended that the following claims be interpreted to embrace all such variations and modifications.

1.-3. (canceled)

4. A security state management (SSM) method that comprises:
intercepting commands directed to a locally-connected cryptoprocessor from one or more sources on a remote computer or virtual machine, thereby obtaining an intercepted command sequence;
monitoring whether the cryptoprocessor is in an authenticated state;
applying a set of one or more security rules to the intercepted command sequence to obtain a modified command sequence, the set including at least one security rule that delays an intercepted command for a cryptographic operation until the cryptoprocesor is in an authenticated state;
detecting that the cryptoprocessor is not in the authenticated state;
inserting one or more commands in the modified command sequence to place the cryptoprocessor in an authenticated state;
directing the modified command sequence to the cryptoprocessor;
receiving from the cryptoprocessor a response to each command in the modified command sequence; and
providing, to the one or more sources, replies for each of the intercepted commands based on the cryptoprocessor responses and on the set of one or more security rules.

5. The method of claim 4, further comprising:
prior to said inserting, prompting a user to provide a personal identification number (PIN) or other identification information; and
generating the one or more inserted commands based at least in part on user-provided information.

6. The method of claim 5, further comprising:
discarding the user-provided information to prevent further usage after said generating.

7. The method of claim 4, further comprising, prior to said inserting, performing an authentication procedure with a security mechanism independent of the cryptoprocessor.

8. The method of claim 7, wherein the security mechanism is a cryptoprocessor-based smart card or trusted platform module.

9. A security state management (SSM) method that comprises:
intercepting commands directed to a locally-connected cryptoprocessor from one or more sources on a remote computer or virtual machine, thereby obtaining an intercepted command sequence;
monitoring whether the cryptoprocessor is in an authenticated state;
applying a set of one or more security rules to the intercepted command sequence to obtain a modified command sequence, the set including at least one security rule that preserves the security state after an authenticated state is reached;
directing the modified command sequence to the cryptoprocessor;
receiving from the cryptoprocessor a response to each command in the modified command sequence; and
providing, to the one or more sources, replies for each of the intercepted commands based on the cryptoprocessor responses and on the set of one or more security rules.

10. The method of claim 9, wherein said at least one security rule prevents the modified command sequence from having commands that would disrupt the authenticated state.

11. A security state management (SSM) method that comprises:
intercepting commands directed to a locally-connected cryptoprocessor from one or more sources on a remote computer or virtual machine, thereby obtaining an intercepted command sequence;
applying a set of one or more security rules to the intercepted command sequence to obtain a modified command sequence;
directing the modified command sequence to the cryptoprocessor;
receiving from the cryptoprocessor a response to each command in the modified command sequence;
determining, based on responses from the cryptoprocessor, a class to which the cryptoprocessor belongs; and
providing, to the one or more sources, replies for each of the intercepted commands based on the cryptoprocessor responses and on the set of one or more security rules, said set including at least one security rule that, based on the cryptoprocessor's class, blocks all or at least some predetermined types of response information from being included in said replies to the one or more sources.

12. The method of claim 11, wherein said determining includes analyzing the cryptoprocessor's answer to reset.

13. A security state management (SSM) method that comprises:
intercepting commands directed to a locally-connected cryptoprocessor from one or more sources on a remote computer or virtual machine, thereby obtaining an intercepted command sequence;
applying a set of one or more security rules to the intercepted command sequence to obtain a modified command sequence;
directing the modified command sequence to the cryptoprocessor;
receiving from the cryptoprocessor a response to each command in the modified command sequence; and
providing, to the one or more sources, replies for each of the intercepted commands based on the cryptoprocessor responses and on the set of one or more security rules,
wherein said providing includes applying an additional security rule to the cryptoprocessor responses to enable source access to only selected types of cryptographic information.

14. The method of claim 13, wherein the selected types of cryptographic information comprise digital certificates issued by a predetermined certification authority.

15.-16 (canceled)

17. A security system that comprises:
a removeable or embedded cryptoprocessor having a persistent key store;
a network interface that receives commands directed via a network to the cryptoprocessor from one or more sources on a remote computer;
a memory or persistent storage device storing security state management (SSM) software; and
one or more central processing units (CPUs) coupled to the memory or persistent storage device to execute the SSM software, the SSM software causing the one or more CPUs to implement an SSM method that includes:
accepting said commands, thereby obtaining a received command sequence;
applying a set of one or more security rules to the received command sequence to obtain a modified command sequence, said applying including:
detecting that the cryptoprocessor is not in the authenticated state;
prompting a user to provide a personal identification number (PIN) or other identification information;
generating one or more commands for authentication based at least in part on the user-provided information; and
inserting the one or more commands for authentication in the modified command sequence to place the cryptoprocessor in an authenticated state;
directing the modified command sequence to the cryptoprocessor;
receiving from the cryptoprocessor responses to commands in the modified command sequence; and
providing, to the one or more sources, replies to commands in the received command sequence based on the cryptoprocessor responses and on the set of one or more security rules, the set of one or more security rules preventing user-provided authentication information from traversing the network.

18. The system of claim 17, wherein as part of applying the set of one or more security rules, the SSM method implemented by the one or more CPUs includes:
discarding the user-provided information to prevent further usage after said generating,
wherein after the cryptoprocessor is placed in the authenticated state, said set of one or more security rules prevents the modified command sequence from having commands that would disrupt the authenticated state.

19. A security system that comprises:
a removeable or embedded cryptoprocessor having a persistent key store;
a network interface that receives commands directed via a network to the cryptoprocessor from one or more sources on a remote computer;
a memory or persistent storage device storing security state management (SSM) software; and
one or more central processing units (CPUs) coupled to the memory or persistent storage device to execute the SSM software, the SSM software causing the one or more CPUs to implement an SSM method that includes:
accepting said commands, thereby obtaining a received command sequence;
applying a set of one or more security rules to the received command sequence to obtain a modified command sequence;
directing the modified command sequence to the cryptoprocessor;
receiving from the cryptoprocessor responses to commands in the modified command sequence;
determining, based on responses from the cryptoprocessor, a class to which the cryptoprocessor belongs; and
providing, to the one or more sources, replies to commands in the received command sequence based on the cryptoprocessor responses and on the set of one or more security rules,
wherein the set of one or more security rules prevents user-provided authentication information from traversing the network, and
wherein said set of one or more security rules, based on the cryptoprocessor's class, blocks all or at least some predetermined types of response information from being included in said replies to the one or more sources.

20. A security system that comprises:
a removeable or embedded cryptoprocessor having a persistent key store;
a network interface that receives commands directed via a network to the cryptoprocessor from one or more sources on a remote computer;
a memory or persistent storage device storing security state management (SSM) software; and
one or more central processing units (CPUs) coupled to the memory or persistent storage device to execute the SSM software, the SSM software causing the one or more CPUs to implement an SSM method that includes:
accepting said commands, thereby obtaining a received command sequence;
applying a set of one or more security rules to the received command sequence to obtain a modified command sequence;
directing the modified command sequence to the cryptoprocessor;
receiving from the cryptoprocessor responses to commands in the modified command sequence; and
providing, to the one or more sources, replies to commands in the received command sequence based on the cryptoprocessor responses and on the set of one or more security rules, said providing including:
applying one or more security rules from the set to the cryptoprocessor responses to block access by the one or more sources to digital certificates not issued by a predetermined certification authority,
wherein the set of one or more security rules prevents user-provided authentication information from traversing the network.
